(19) United States
(12) Patent Application Publication
(10) Pub. No.: US 2019/0366671 A1
(43) Pub. Date: Dec. 5, 2019

(54) TOOL HEAD FOR A PRESSING MACHINE

(71) Applicant: Von Arx AG, Sissach (CH)

(72) Inventors: Rudolf KREUZER, Buchs (CH); Andreas STUCKI, Gelterkinden (CH)

(21) Appl. No.: 16/423,342

(22) Filed: May 28, 2019

(30) Foreign Application Priority Data
May 29, 2018 (EP) EP 18174752.8

(51) Int. Cl. B30B 15/04; B25B 27/02

(52) U.S. Cl. CPC B30B 15/047; B25B 27/02

(57) ABSTRACT

A tool head for a pressing machine and a pressing machine for plastically deforming a tubular workpiece are described. In many applications, the tubular workpiece is a fitting. The tool head includes a base body, a fixed press jaw and a linearly movable press jaw. A spring element is arranged to preload the movable press jaw against a workpiece without plastically deforming the workpiece.

### FIELD

The present invention relates to a tool head for a pressing machine, in particular for a pipe pressing machine, for the plastic deformation of a tubular workpiece, in particular a fitting. Furthermore, the invention relates to a pressing machine and a method for operating such a pressing machine.

### BACKGROUND

In the state of the art, several processes for joining tubular workpieces are known. For example, tubes can be soldered or welded together. It is also known to insert the end of a smaller tube into the end of a larger tube and then press both tube ends together.

In other cases, pressing is carried out with the aid of a (press) fitting. Pressing machines, such as pipe pressing machines, can be used to connect a pipe to a press fitting. Such a fitting can, for example, be designed as a pipe fitting which can be used as a connecting piece of a pipe. The pipe ends to be connected are inserted into the fitting and the fitting is then pressed onto the pipe ends. A fitting can be made of various materials such as copper, aluminum, plastic, composite and/or (stainless) steel.

A (tube) pressing machine may include press jaws made of metal, such as aluminum, titanium or steel, which may be interchangeable. The press jaws can also be made of a composite material. Furthermore, the pressing machine can include an interchangeable tool head, such as a press pliers, which comprises the press jaws. A force can be applied to the fitting by means of the press jaws or the press pliers in order to plastically deform it in such a way that the fitting lies as flushly, tightly and firmly as possible against a pipe (or pipe end). When such a pressing machine is used, the press jaws are pivoted relative to each other and pressed together in order to press a fitting arranged in between onto a pipe. The pressing machine can be hand-guided and may be driven by a drive. Typically, electric and/or hydraulic drives are used.

The pivoting of the press jaws leads to an undesired press burr formation at the fitting. Furthermore, pivoting leads to a non-uniform application of the pressing force. For example, pivoting the press jaws in an area adjacent to the pivot axis applies a higher pressing force than in an area remote from the pivot axis. This leads to non-uniform pressing. Particularly when pressing sensitive fittings, such as very thin-walled fittings, a maximum permissible pressing force can be exceeded in certain areas (e.g. adjacent to the pivot axis), while the required pressing force is not achieved in an area remote from the pivot axis, for example.

In addition, known tool heads are voluminous and can only be used to a limited extent in confined areas. In particular, pivoting of the press jaws relative to each other causes the circumferential volume of known tool heads to change considerably when the press jaws are opened, so that known tool heads are not or only to a limited extent suitable for use in confined areas, such as in the assembly of air-conditioning systems or heaters, especially when retrofitting air-conditioning or heating modules.

Furthermore, well-known tool heads are often difficult to position accurately enough, so that the workpiece to be pressed (fitting) cannot be gripped ideally prior to pressing. This can lead to a deformation of the workpiece at an area which is not intended for the deformation, so that ultimately the tightness of the connection of the tubular workpieces cannot be guaranteed.

Accordingly, tool heads that address these issues and ideally that overcome these problems would be beneficial. In addition, pressing machines utilizing such tool heads are desirable and would provide advantages and improvements for users.

### SUMMARY

The difficulties and drawbacks associated with previous approaches are addressed in the present subject matter as follows.

In one aspect, the present subject matter provides a tool head for a pressing machine for plastically deforming a tubular workpiece. The tool head comprises a base body, a fixed press jaw which is arranged on the base body, a linearly movable press jaw, a spring element adapted to preload said movable press jaw against a workpiece without plastically deforming said workpiece, and a machine coupling for coupling the tool head to a pressing machine.

In another aspect, the present subject matter provides a pressing machine for plastically deforming a tubular workpiece. The pressing machine comprises a handle, a tool head receptacle, and a tool head receivable in the tool head receptacle. The tool head includes a base body, a fixed press jaw which is arranged on the base body, a linearly movable press jaw, a spring element adapted to preload said movable press jaw against a workpiece without plastically deforming said workpiece, and a machine coupling for coupling the tool head to the pressing machine.

In yet another aspect, the present subject matter provides a method for operating a tool head to plastically deform a tubular workpiece. The method comprises providing a pressing machine for plastically deforming a tubular workpiece. The method also comprises providing a tool head including a base body, a fixed press jaw which is arranged on the base body, a linearly movable press jaw, a spring element adapted to preload said movable press jaw against a workpiece without plastically deforming said workpiece, and a machine coupling for coupling the tool head to the pressing machine. The method also comprises gripping the workpiece by means of the fixed press jaw of the tool head. The method additionally comprises preloading the movable press jaw against the workpiece by means of the spring element in order to finely align the tool head relative to the workpiece. And, the method comprises generating a force by the press jaws on the surface of the gripped workpiece to plastically deform the workpiece.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

FIG. 1 shows a schematic illustration of a pressing machine.

FIG. 2A shows a schematic illustration of a tool head according to an embodiment of the present invention.

FIG. 2B shows a schematic sectional view of the tool head of FIG. 2A.

FIG. 3A shows a schematic illustration of the tool head of FIG. 2A in an open position.

FIG. 3B shows a schematic sectional view of the tool head of FIG. 3A.

### DETAILED DESCRIPTION OF THE EMBODIMENTS

This invention is therefore based on the object of providing a tool head that is small and easy to position and can apply a uniform pressing force. These and other tasks, which are apparent to the skilled person from the following description, are addressed by a tool head for a pressing machine, a pressing machine using such a tool head, and a method for operating a pressing machine as described herein.

The present invention relates to a tool head for a pressing machine, in particular a pipe pressing machine, for the plastic deformation of a tubular workpiece, in particular a fitting. The tubular workpiece can, for example, be a fitting and can be pressed to connect two pipes. The fitting can, for example, consist at least partially of copper, aluminum, plastic, composite and/or stainless steel. The tool head or pressing machine can be set up to plastically deform such a tubular workpiece, such as a fitting, so that it is connected to a piece of pipe arranged in the fitting. In particular, pressing can be carried out by means of the pressing machine or the tool head in order to connect a fitting to a pipe in a form-fitting connection and/or non-positively connection in a non-detachable manner. The fitting can, for example, be specified according to the standard DIN EN 1254-7.

The tool head also comprises a base body on which a fixed press jaw is arranged. Furthermore, the tool head comprises a linearly movable press jaw, which is linearly movable relative to the fixed press jaw. This means that the movable press jaw is designed to move in a straight line relative to the fixed press jaw. By means of a machine coupling, the tool head can be coupled with a pressing machine, in particular in such a way that the pressing machine can drive the press jaws (in particular the linearly movable press jaw).

For example, the coupling is carried out via at least one pin. The press jaws of the press jaw arrangement are arranged so as to be movable relative to one another, in particular the linearly movable press jaw can be moved from a first to a second position, the press jaws being open in the first position and closed in a second position. In the first position (i.e. in the open position), for example, a tubular workpiece, such as a fitting, can be arranged between the press jaws.

The press jaws of the tool head can also be exchangeable. This means that different workpieces, which differ in terms of material and/or circumference, for example, can be pressed with the tool head. Suitable (workpiece-specific) press jaws are inserted into the tool head for this purpose.

Furthermore, the tool head includes a spring element that is designed to preload the movable press jaw against a workpiece without plastically deforming it when the workpiece is arranged between the press jaws. By preloading the movable press jaw against the workpiece by means of the spring element, positioning of the tool head is facilitated. Thus, an exact pressing or a correct deformation of the workpiece can be carried out, respectively. In order to achieve exact pressing, the fixed press jaw is first aligned with the workpiece and then the movable press jaw is moved from the first, open position and preloaded against the workpiece. By means of the spring element, a sufficient preload force can be applied to the workpiece, which ensures that the tool head no longer gets out of place and is precisely positioned. The preload force can also be selected so that minor readjustments to the position of the tool head are still possible. After checking the correct position of the tool head, the pressing force can be applied and the tubular workpiece can be plastically deformed.

The deforming is carried out by means of a linear movement of at least one press jaw. Due to the linear movement of the press jaw, the movable press jaw can be moved linearly towards the fixed press jaw. This leads to a uniform application of the pressing force. Furthermore, the linear movement of the press jaw and the corresponding application of force can largely or even completely prevent the formation of a press burr, so that a tight pressing is achieved. Furthermore, the linear movement of the moving press jaw allows the construction of a tool head with small dimensions. In particular, the volume circumscribing the tool head in the open and closed state is very small, so that the tool head can also be used in narrow spaces and, for example, can be moved past existing pipelines. Such a tool head is particularly suitable for pressing workpieces during the assembly of air conditioning systems or when retrofitting heating or air conditioning modules in existing heating or air conditioning systems.

The machine coupling can be designed in such a way that the base body of the tool head is held in the pressing machine, while the movable press jaw is moved by a drive of the pressing machine and thus the pressing force is applied to the workpiece.

Furthermore, the base body can be C-shaped. This simplifies the initial alignment or positioning of the tool head on the workpiece. For example, the base body, including the fixed press jaw, can be hooked onto the workpiece and thus easily aligned. In particular, the tool head can be hooked onto the workpiece so that the tool head is fixed to the workpiece to a certain extent even before the preload force is applied.

Furthermore, the movable press jaw can be moved by the spring element from a first position to a second position, whereby the press jaws are preferably fully open in the first position and closed in the second position, or rest against the workpiece or against each other. The complete opening of the press jaws (i.e. in the first position) simplifies the insertion of the fitting or the workpiece and the alignment of the tool head on the workpiece, as the workpiece can easily be inserted between the press jaws.

In addition, the tool head can include a locking device designed to lock the movable press jaw, preferably in the first, i.e. open, position. Due to the locking mechanism, the tool head does not have to be held open manually when positioning the tool head on the workpiece. Rather, the movable press jaw can be brought into the first position and locked in this position. The tool head can then be aligned relative to the workpiece. After releasing the lock, the spring element can move the movable press jaw from the first position and apply a preload force to the workpiece. This simplifies the alignment of the tool head relative to the workpiece and minimizes the risk of incorrect pressing.

In particular, the locking device can also be designed to release the movable press jaw so that the spring element preloads the press jaw against the workpiece. For this purpose, the locking device preferably has an unlocking device, such as an unlocking lever. If the tool head or the fixed press jaw is aligned with the workpiece, the locking or unlocking device can (automatically) move the movable press jaw from the first position and preload it against the workpiece. This ensures simple operation.

The spring element can be equipped to apply a pre-settable preload force to the tool by means of the movable press jaw, whereby the spring element preferably comprises a spiral spring. Other spring types are also possible. For example, a pneumatic, hydraulic or other spring or a combination of different springs can be used. A pre-settable preload force is advantageous as it allows the preload force to be adapted to different workpieces or fittings. For example, a steel fitting can be preloaded with a different preload force than, for example, a plastic fitting. The preload force can also be adjusted in relation to the material thickness of the fitting. This ensures that the fitting is not damaged or plastically deformed by the application of the preload force.

In particular, the pre-settable preload force can be adjusted in a range from 5 to 50 N, preferably in a range from 7 to 40 N and most preferably in a range from 10 to 30 N. The adjustment can be stepless or stepwise. In the mentioned ranges of the preload force, it can be ensured that the tool head is securely positioned on the workpiece and preloaded against the workpiece so that no further undesired relative movement takes place between the workpiece and the tool head. Furthermore, there is no plastic deformation of typical workpieces in the aforementioned ranges of the preload force before the actual pressing force is applied.

In addition, the tool head can have a positioning aid which is preferably adapted to the workpiece to be pressed, whereby the positioning aid can in particular be designed in the form of a recess. The positioning aid allows a positive positioning of the tool head on the workpiece. For example, the workpiece can include a projection and the positioning aid can be designed in the form of a recess. For example, the positioning aid can be designed on at least one press jaw, preferably the stationary one. The positioning aid can also be designed on the base body. When positioning the tool head on the workpiece, the positioning aid engages with the corresponding projection of the workpiece, thus simplifying the alignment of the tool head. In particular, the positioning aid can be set up in such a way that the tool head is guided into the desired orientation. This is made possible, for example, by a trapezoidal recess that allows the workpiece to be easily inserted into the positioning aid and then leads to the desired alignment of the workpiece in the positioning aid.

Furthermore, at least one of the press jaws of the tool head can be an exchangeable press jaw. By exchanging the press jaws, the tool head can be adapted to different workpieces. For example, workpieces made of different materials such as plastic, copper, aluminum, composite, steel or stainless steel can be processed. The press jaws are then made of an appropriate material, which enables plastic deformation of the workpiece. The exchangeable press jaw can also be used to plastically deform workpieces with a different diameter. For example, the workpieces can have a diameter in the range of 5 mm to 50 mm. By providing at least one corresponding press jaw with a corresponding tool holder, workpieces with different diameters can be pressed with the same tool head.

In particular, the press jaws can be arranged at least 6 mm in the first position, preferably at least 10 mm, even more preferably at least 12 mm, even more preferably at least 15 mm and most preferably at least 20 mm apart from each other. The distance between the press jaws is to be understood as the clear width “D”, so that correspondingly large workpieces can be inserted between the press jaws.

The clear width between the press jaws is preferably selected at least as large that the unpressed workpiece (i.e. the unpressed fitting) can be inserted between the press jaws. By providing a correspondingly large width, it is possible to insert a workpiece easily between the press jaws. In addition, the width must be sufficiently small to allow fast pressing and to avoid unnecessary movements of the moving press jaw. This makes efficient pressing possible.

In particular, the press jaws may be adapted to apply to the workpiece a pressing force of at least 2 kN, preferably of at least 8 kN, preferably of at least 10 kN, even more preferably of at least 18 kN and most preferably of at least 24 kN. Thus, workpieces of different materials can be plastically deformed. In addition, the pressing machine or tool head can be set up to adjust the pressing force so that different workpieces can be pressed without being damaged. This ensures a tight connection between the pipe sections.

The machine coupling of the tool head is preferably arranged in such a way that the tool head can be rotatably coupled with the pressing machine. The tool head can preferably be rotated about a longitudinal axis. This enables the tool head to be rotated in different orientations without having to rotate the actual pressing machine. Thus, the tool head can also be used in narrow areas or installation spaces. If, for example, the pressing machine is equipped with a handle, the opening between the press jaws can be oriented to the respective workpiece. If, for example, a pipe connection is to be pressed on a ceiling of a room, the handle of the pressing machine can point downwards, while the opening between the press jaws is oriented upwards. Accordingly, when working a pipe connection on a wall, the opening can be oriented sideways to the handle. Thus, the ideal orientation of the tool head or the opening for the respective installation situation can be selected and optimum pressing can be achieved.

Furthermore, the linearly movable press jaw is preferably set up in such a way that it cannot carry out any rotational movements relative to the fixed press jaw.

Furthermore, the object is solved by a pressing machine, in particular a tube pressing machine for the plastic deformation of a tubular workpiece, which comprises a handle and a tool head receptacle. The tool head receptacle accommodates one of the tool heads described above.

In particular, the pressing machine can include a drive which is designed to drive the press jaws. In particular, the drive output is arranged to move the linearly movable press jaw to apply a force to the workpiece. The drive can comprise an electric motor, a pneumatic and/or a hydraulic drive unit as well as a gear. By means of the drive, the press jaws or the linear moving press jaw can be moved relative to the fixed press jaw. In particular, at least one press jaw can be moved from the first to the second position (and back). The drive can apply the force necessary to plastically deform the tubular workpiece. Thus, for example, a fitting can be tightly connected to a piece of pipe.

The drive can be coupled directly or via a gear with the movable press jaw to transfer the driving force to the press jaw(s). The force acting on the press jaws can preferably be set variably. This can be done, for example, by adjusting at least one motor parameter or another parameter, such as a gear setting.

The tool head receptacle typically comprises a coupling means, such as a pin, which couples to the base body of the tool head. A moving part of the tool head receptacle transmits the driving force from the drive to the moveable press jaw.

In addition, the pressing machine can be manually operated and/or have an electric and/or hydraulic drive, which for example additionally includes a gear. Manually operated pressing machines have small dimensions, but are limited in the maximum pressing force that can be applied. Electrically or hydraulically operated pressing machines can apply a higher pressing force, but typically have a larger design. In the case of electrically operated drives, the pressing machine can be battery-powered and/or operated from the mains.

Furthermore, the object is solved by a method for operating a tool head described above, the method comprising the provision of a pressing machine, in particular a tube pressing machine, for plastically forming a tubular workpiece and the provision of a corresponding tool head. A workpiece is then gripped by means of the fixed press jaw of the tool head. The movable press jaw is preloaded against the workpiece by means of the spring element in order to finely align the tool head relative to the workpiece. A pressing force is then generated by the pressing machine so that the press jaws exert a force on the surface of the gripped workpiece to plastically deform the workpiece.

The linear movement of the moving press jaw prevents the formation of a press burr and ensures uniform force application. In addition, the preloading of the moving press jaw allows the tool head or pressing machine to be finely aligned relative to the workpiece, so that precise pressing can be carried out.

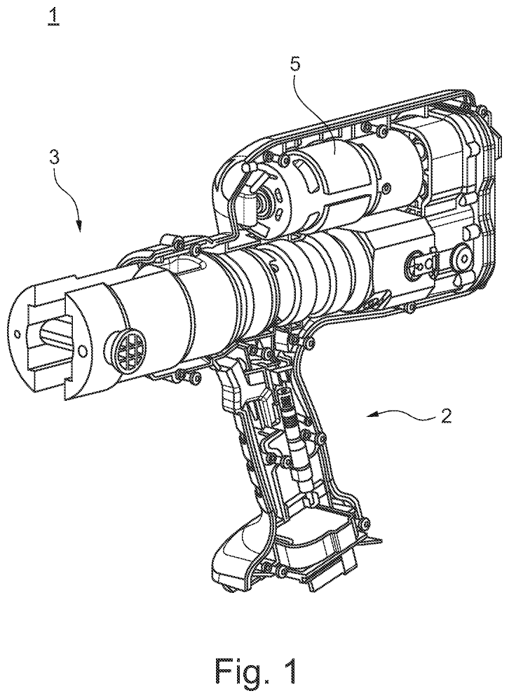

FIG. 1 shows a pressing machine 1 that includes a handle 2 that can be manually operated by an operator or user. A tool head 10 can be detachably coupled to the pressing machine 1 by means of a tool head receptacle 3.

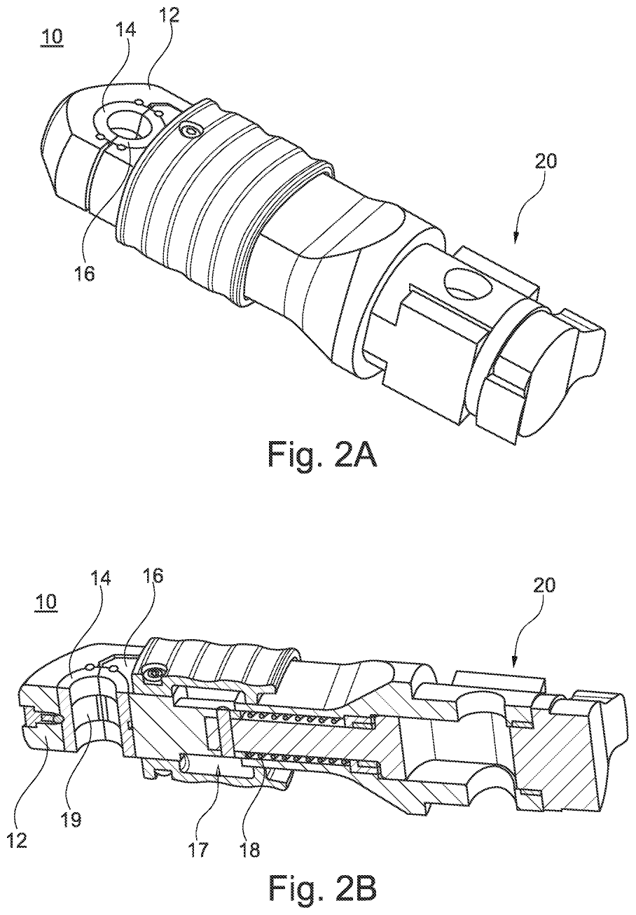

The pressing machine 1 also includes a drive 5. The drive 5 can be an electric motor with a gear, which drives the tool head 10 via the tool head receptacle 3 and can thus move a linearly movable press jaw 16 to plastically deform a workpiece. To deform the fitting, an operator can actuate an appropriate lever. By actuating the actuating lever, the linearly movable press jaw 16 of the tool head 10 is first moved away from the fixed press jaw 14 (see FIG. 2A). A workpiece or fitting can then be gripped. Then the movable press jaw 16 can be preloaded against the gripped fitting and by (re-)actuating the actuating lever a force can be applied to the fitting via the press jaws 14, 16 by means of the drive 5 in order to plastically deform the fitting.

The tool head 10 is coupled with the pressing machine 1 via the tool head receptacle 3, which can, for example, include a pin that couples with a base body 12 of the tool head 10. In addition, the tool head receptacle 3 can include a movable part which transmits the driving force from the drive 5 to the linearly movable press jaw 16.

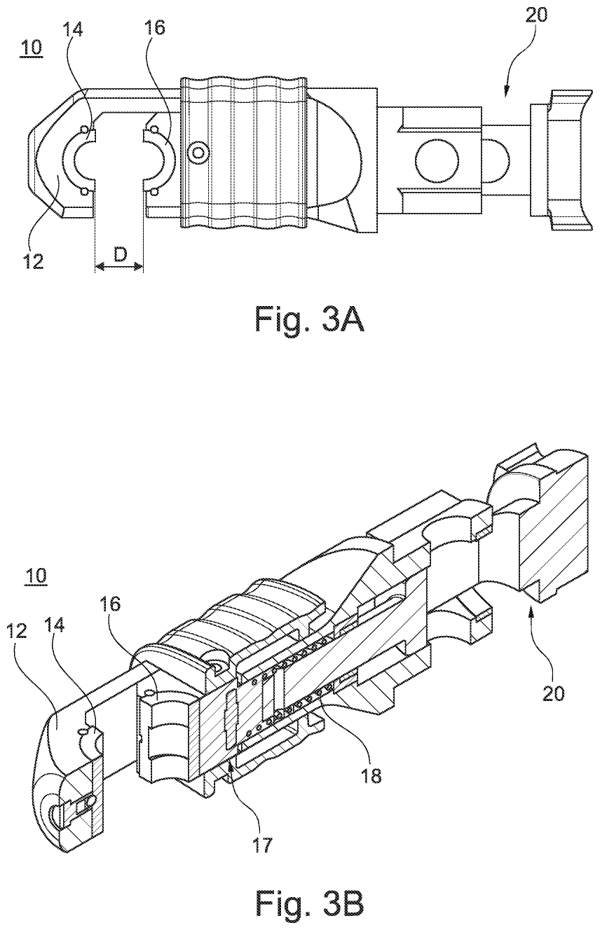

FIGS. 2A and 2B show an example tool head in a second position, i.e. a closed position, while FIGS. 3A and 3B show the tool head in a fully open position (i.e. the first position). In FIGS. 2A to 3B, the same parts are each marked with the same reference sign.

FIG. 2A shows a tool head 10 that can be detachably coupled to a pressing machine 1 (see FIG. 1). The tool head 10 comprises a machine coupling 20, which can be engaged with the tool head receptacle 3 of the pressing machine 1. Machine coupling 20 can in particular include a reception for a pin. The reception for the pin is preferably attached to a base body 12 of the tool head 10. A movable part of the machine coupling 20 is preferably arranged to engage with a movable part of the tool head receptacle 3 in order to transfer a pressing force from a drive 5 of the pressing machine 1 to the movable press jaw 16 of the tool head 10.

In particular, the tool head 10 comprises a C-shaped base body 12, on which a fixed press jaw 14 is arranged. This fixed press jaw 14 can first be applied to a workpiece, such as a fitting, before the linearly movable press jaw 16 is preloaded against the workpiece and the fixed press jaw 14. A force for plastic deformation of the workpiece can then be applied by means of the linearly movable press jaw 16. The linearly movable press jaw 16 is linearly guided in the tool head 10. In particular, the press jaws 14, 16 can be individually or together exchangeable in order to deform workpieces of different types (e.g. material, size) with the tool head 10.

FIG. 2B shows a section of the closed tool head 10 from FIG. 2A. The press jaws 14 and 16 touch each other at least partially. Press jaws 14 and 16 are in a closed position (second position).

The press jaws can comprise a recessed groove 19, which can serve as a positioning aid. If the workpiece comprises a corresponding projection, this positioning aid 19 can be used to align the press jaws 14, 16 correctly with the workpiece.

Furthermore, the tool head 10 comprises a spring element 18, which is designed as a spiral spring. By means of the spring element 18, the movable press jaw 16 can be preloaded against a workpiece located between the press jaws 14 and 16. Thus the pressing machine 1 or the tool head 10 can be aligned and fixed to the workpiece. After applying the preload force, a fine alignment of the tool head can also be possible. This enables precise pressing. After preloading, a corresponding pressing force can be applied to the workpiece by means of the drive 5 via the linearly movable press jaw 16.

Furthermore, the tool head 10 comprises a locking device 17, which can, for example, comprise a pin, the locking device 17 can, for example, engage in a corresponding receptacle of the base body 12 in order to lock the linearly movable press jaw 16 in the first, open position (see FIG. 3A). The first position is preferably a position in which the press jaws 14, 16 are opened at maximum. The clear width D is maximum here and is, for example, 6 mm, preferably 8 mm even more preferably 12 mm, most preferably 15 mm and most preferably 20 mm. This simplifies the insertion of different fittings into or between press jaws 14, 16.

FIG. 3B shows the tool head in open position in a cut view. The locking device 17 is in the locked state and secures the linearly movable press jaw in the first, open position. By releasing the locking device, the linearly movable press jaw 16 can be moved towards the fixed press jaw 14 and is preloaded against a workpiece. In particular, the linear movement enables the pressing force to be applied evenly, thus preventing the formation of a press burr.

### LIST OF REFERENCE SIGNS

1 pressing machine
2 handle
3 tool head receptacle
5 drive
10 tool head
12 base body
14 fixed press jaw
16 linear movable press jaw
17 locking device
18 spring element
19 positioning aid
20 machine coupling
D clear opening of the press jaws

Many other benefits will no doubt become apparent from future application and development of this technology.

All patents, applications, standards, and articles noted herein are hereby incorporated by reference in their entirety.

The present subject matter includes all operable combinations of features and aspects described herein. Thus, for example if one feature is described in association with an embodiment and another feature is described in association with another embodiment, it will be understood that the present subject matter includes embodiments having a combination of these features.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

What is claimed is:

1. A tool head for a pressing machine for plastically deforming a tubular workpiece, the tool head comprising:
a base body;
a fixed press jaw which is arranged on the base body;
a linearly movable press jaw;
a spring element adapted to preload said movable press jaw against a workpiece without plastically deforming said workpiece; and
a machine coupling for coupling the tool head to a pressing machine.

2. The tool head according to claim 1, wherein the base body is C-shaped.

3. The tool head according to claim 1, wherein the movable press jaw can be moved by the spring element from a first position into a second position.

4. The tool head according to claim 3 wherein the press jaws are completely opened in the first position.

5. The tool head according to claim 1, wherein the tool head further comprises a locking device that is adapted to lock the movable press jaw.

6. The tool head according to claim 5 wherein the locking device is adapted to lock the movable press jaw in the second position.

7. The tool head according to claim 5, wherein the locking device is adapted to release the movable press jaw so that the spring element preloads the press jaws against the workpiece.

8. The tool head according to claim 1, wherein the spring element is adapted to apply a pre-settable preload force to the workpiece by means of the movable press jaw.

9. The tool head according to claim 8 wherein the spring element comprises a spiral spring.

10. The tool head according to claim 8, wherein the preload force is in the range from 5 N to 50 N.

11. The tool head according to claim 1, wherein the tool head further comprises a positioning aid in the form of a recess that is adapted to a workpiece to be pressed.

12. The tool head according to claim 1, wherein at least one press jaw is an exchangeable press jaw.

13. The tool head according to claim 3, wherein the press jaws are arranged in the first position at least 6 mm apart from each other.

14. The tool head according to claim 1, wherein the press jaws are adapted to apply to the workpiece a pressing force of at least 2 kN.

15. The tool head according to claim 1, wherein the machine coupling is arranged such that the tool head can be rotatably coupled to the pressing machine.

16. A pressing machine for plastically deforming a tubular workpiece, the pressing machine comprising:
a handle;
a tool head receptacle;
a tool head receivable in the tool head receptacle, the tool head including:
a base body;
a fixed press jaw which is arranged on the base body;
a linearly movable press jaw;
a spring element adapted to preload said movable press jaw against a workpiece without plastically deforming said workpiece; and
a machine coupling for coupling the tool head to the pressing machine.

17. The pressing machine according to claim 16 wherein the pressing machine is a pipe pressing machine.

18. The pressing machine according to claim 16, wherein the pressing machine is manually operable.

19. The pressing machine according to claim 16 wherein the pressing machine further comprises a drive and the drive is selected from an electric drive and a hydraulic drive.

20. A method for operating a tool head to plastically deform a tubular workpiece, the method comprising:
providing a pressing machine for plastically deforming a tubular workpiece,
providing a tool head including a base body, a fixed press jaw which is arranged on the base body, a linearly movable press jaw, a spring element adapted to preload said movable press jaw against a workpiece without plastically deforming said workpiece, and a machine coupling for coupling the tool head to the pressing machine;
gripping the workpiece by means of the fixed press jaw of the tool head;
preloading the movable press jaw against the workpiece by means of the spring element in order to finely align the tool head relative to the workpiece;
generating a force by the press jaws on the surface of the gripped workpiece to plastically deform the workpiece.
